(19) United States
(12) Patent Application Publication
(10) Pub. No.: US 2014/0007743 A1
(43) Pub. Date: Jan. 9, 2014

(54) WRENCH WITH GRIP ENHANCING APPARATUS

(71) Applicant: THRU TUBING SOLUTIONS, INC., Oklahoma City, OK (US)

(72) Inventors: Brock Watson, Oklahoma City, OK (US); Roger Schultz, Ninnekah, OK (US)

(73) Assignee: Thru Tubing Solutions, Inc., Oklahoma City, OK (US)

(21) Appl. No.: 13/865,551

(22) Filed: Apr. 18, 2013

Related U.S. Application Data
(60) Provisional application No. 61/667,565, filed on Jul. 3, 2012.

(51) Int. Cl. B25B 13/50

(52) U.S. Cl. CPC B25B 13/5058
USPC 81/129

(57) ABSTRACT

This disclosure is related to an adjustable wrench for engaging work objects. The adjustable wrench has a handle having a handle end and a flat serrated jaw surface. The adjustable wrench also has an L-shaped movable jaw having a lever arm and a serrated jaw, the lever arm having a terminal end and an opening therein. The adjustable wrench further comprises a projection extending from the handle having a tunnel therein for accepting the lever arm of the L-shaped movable jaw and a grip enhancing apparatus.

### CROSS-REFERENCE TO RELATED APPLICATIONS

The present application is a conversion of U.S. Provisional Application having U.S. Ser. No. 61/667,565, filed Jul. 3, 2012, which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to a wrench that includes a grip enhancing apparatus to more efficiently engage a work object.

2. Description of the Related Art

Traditionally, pipe wrenches are adjustable wrenches used for fitting and turning rounded surfaces. A user manipulates the wrench to fit the rounded surface and then must apply pressure to the wrench to engage the rounded surface and turn it. If a user does not continue to apply force to the wrench, the wrench will not stay engaged on the rounded surface and would fall to the ground if the user does not hold it. Accordingly, there is a need for a wrench that can stay engaged on a rounded surface without the user having to hold the wrench and continually apply pressure to the wrench.

### SUMMARY OF THE INVENTION

The present disclosure is directed to an adjustable wrench for engaging a work object. The wrench includes a handle having a handle end and a flat serrated jaw surface. The wrench also includes an L-shaped movable jaw having a lever arm and a serrated jaw, the lever arm having a terminal end and an opening therein. The wrench further includes a projection extending from the handle having a tunnel therein for accepting the lever arm of the L-shaped movable jaw. Additionally, the wrench includes a grip enhancing apparatus. The grip enhancing apparatus includes a threaded nut element disposed adjacent to the lever arm, the threaded nut element having a threaded opening therein. The grip enhancing apparatus also includes a threaded shaft for extending through the opening of the lever arm and engaging the threaded opening of the threaded nut element. The threaded shaft can extend through the threaded nut element and contact the handle of the adjustable wrench, forcing the L-shaped movable jaw away from the handle and the serrated jaw of the L-shaped movable jaw is forced toward the flat serrated jaw surface.

### BRIEF DESCRIPTION OF THE DRAWINGS

FIG. 1 is a perspective view of an adjustable wrench with grip enhancing apparatus constructed in accordance with the present disclosure.

FIG. 2 is a cross-sectional view of another embodiment of the adjustable wrench with grip enhancing apparatus constructed in accordance with the present disclosure.

FIG. 3 is a perspective view of another embodiment of the adjustable wrench with grip enhancing apparatus constructed in accordance with the present disclosure.

FIG. 4 is a cross-sectional view of another embodiment of the adjustable wrench with grip enhancing apparatus constructed in accordance with the present disclosure.

FIG. 5 is a perspective view of another embodiment of the adjustable wrench with grip enhancing apparatus constructed in accordance with the present disclosure.

FIG. 6 is a cross-sectional view of another embodiment of the adjustable wrench with grip enhancing apparatus constructed in accordance with the present disclosure.

FIG. 7 is a perspective view of another embodiment of the adjustable wrench with grip enhancing apparatus constructed in accordance with the present disclosure.

### DETAILED DESCRIPTION OF THE INVENTION

The present disclosure relates to an adjustable wrench 10 that includes a grip enhancing apparatus 12 to more efficiently engage a work object 14. The work object 14 can be anything capable of having the adjustable wrench 10 used thereon. In one embodiment, the adjustable wrench 10 can be a any type of pipe wrench known in the art.

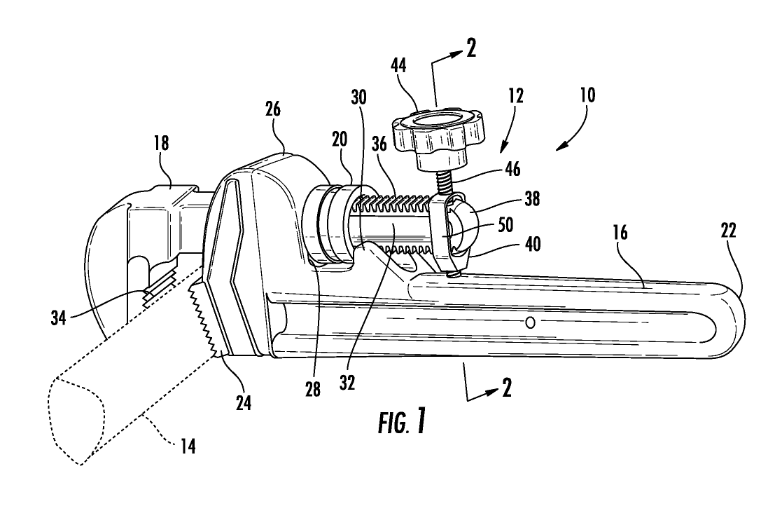

As shown in FIG. 1, an adjustable wrench 10 can include a handle 16, an L-shaped movable jaw 18 and an adjustment nut 20 for positioning the L-shaped movable jaw 18 (or hook jaw) respective of the handle 16. The handle 16 has a handle end 22, a flat serrated jaw surface 24 for engaging the work object 14, and a first projection 26 disposed on the handle 16 adjacent to the flat serrated jaw surface 24. The first projection 26 includes an adaptively-sized tunnel 28 disposed therethrough. The handle 16 can also include a second projection 30 disposed on the handle 16 that cooperates with the first projection 26 to hold and maintain the adjustment nut 20 therebetween.

The L-shaped movable jaw 18 has a lever arm 32 and a serrated jaw 34 for further engagement of the work object 14. The lever arm 32 includes threads 36 that engage the adjustment nut 20 and a terminal end 38 disposed at the opposite end of the L-shaped movable jaw 18 from the serrated jaw 34. Furthermore, the lever arm 32 of the L-shaped movable jaw 18 can be positioned within the tunnel 28 of the first projection 26 of the handle 16. The second projection 30 of the handle 16 is sized such that it does not interfere with the lever arm 32 of the L-shaped movable jaw 18 as it extends through the tunnel 28.

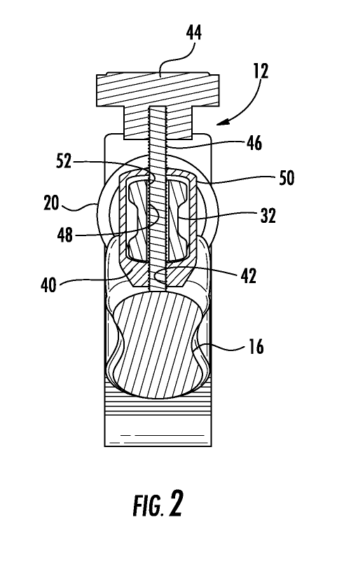

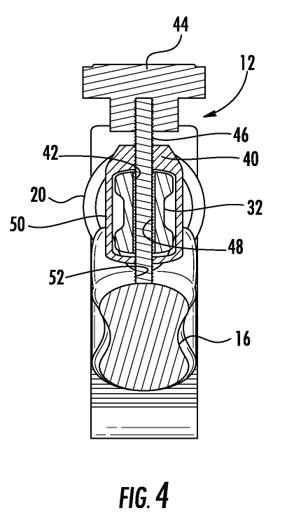

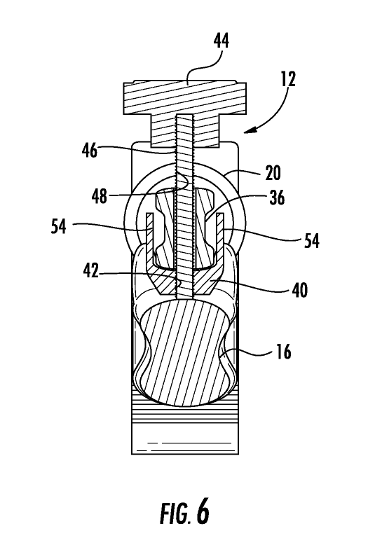

In various embodiments, shown in FIGS. 1-7, the adjustable wrench 10 can also include the grip enhancing apparatus 12. In these embodiments, the grip enhancing apparatus 12 includes a threaded nut element 40, a threaded opening 42 disposed in a portion of the threaded nut element 40, and a threaded shaft 46 to engage the threaded opening 42 of the threaded nut element 40. In another embodiment of the present disclosure, the grip enhancing apparatus 12 can include a turn handle 44 attachable to the threaded shaft 46 or, in certain embodiments, the threaded nut 40. It should be understood that the turn handle 44 can be positioned anywhere on the threaded shaft 46 relative to the handle 16 and lever arm 32 and the turn handle 44 can be any apparatus capable of being grasped by a user and be turned. In these embodiments, the terminal end 38 of the lever arm 32 of the L-shaped movable jaw 18 has a passageway 48 disposed therein, whereby the threaded shaft 46 of the grip enhancing apparatus 12 can extend therethrough.

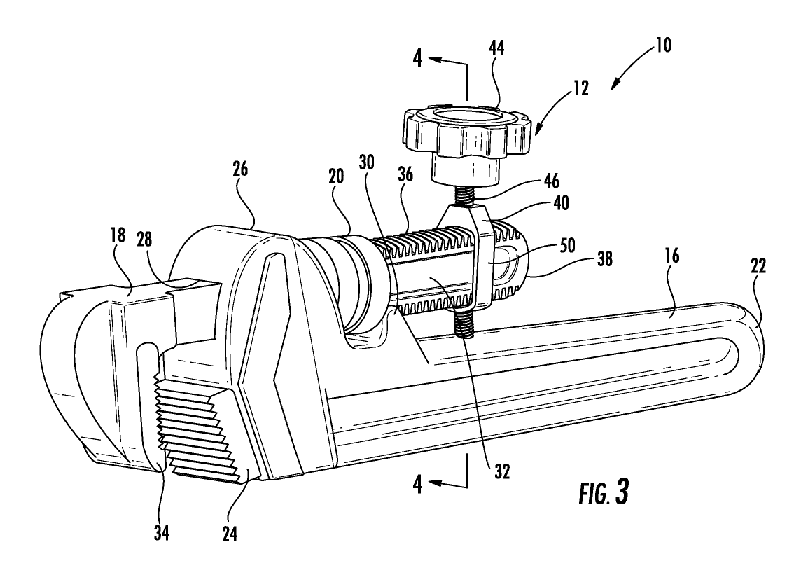

The threaded nut element 40 of the present disclosure can take on a number of shapes and sizes. In two embodiments, shown in FIGS. 1 and 3, the threaded nut element 40 includes a ring portion 50 attached thereto that extends around the terminal end 38 of the lever arm 32 to prevent the threaded nut element 40 from turning as the turn handle 44 turns the threaded shaft 46. The ring portion 50 of the threaded nut element 40 includes an opening 52 for permitting the threaded shaft 46 to extend therethrough and generally align with the threaded opening 42 of the threaded nut element 40. In one embodiment, shown in FIG. 1, the threaded opening 42 of the threaded nut element 40 is disposed between the terminal end 38 of the lever arm 32 and the handle 16 of the adjustable wrench 10. In another embodiment, shown in FIG. 3, the threaded opening 42 of the threaded nut element 40 is disposed on the opposite side of the terminal end 38 of the lever arm 32 from the handle 16 of the adjustable wrench 10.

In use, the threaded shaft 46 of the grip enhancing apparatus 12 extends through the passageway 48 in the terminal end 38 of the lever arm 32 and the opening 52 in the ring portion 50 of the threaded nut element 40 and engages the threaded opening 42 of the threaded nut element 40. The ring portion 50 of the threaded nut element 40 may contact the terminal end 38 of the lever arm 32 and prevent the threaded nut element 40 from turning when the threaded opening 42 of the threaded nut element 40 is being engaged by the threaded shaft 46. As the threaded shaft 46 continues to engage the threaded nut element 40, the threaded shaft 46 ultimately contacts the handle 16 of the adjustable wrench 10. As the turn handle 44 of the grip enhancing apparatus 12 is turned and continues to force the threaded shaft 46 to engage the handle 16, the lever arm 32 of the L-shaped movable jaw 18 is forced away from the handle 16 and the serrated jaw 34 of the L-shaped movable jaw 18 is forced toward the flat serrated jaw surface 24 of the handle 16. At a certain point, the work object 14 is securely engaged by the serrated jaw 34 of the L-shaped movable jaw 18 and the flat serrated jaw surface 24 of the handle 16 and the wrench 10 can remain engaged on the work object 14 without a user having to maintain any pressure on the wrench 10 or hold the wrench 10.

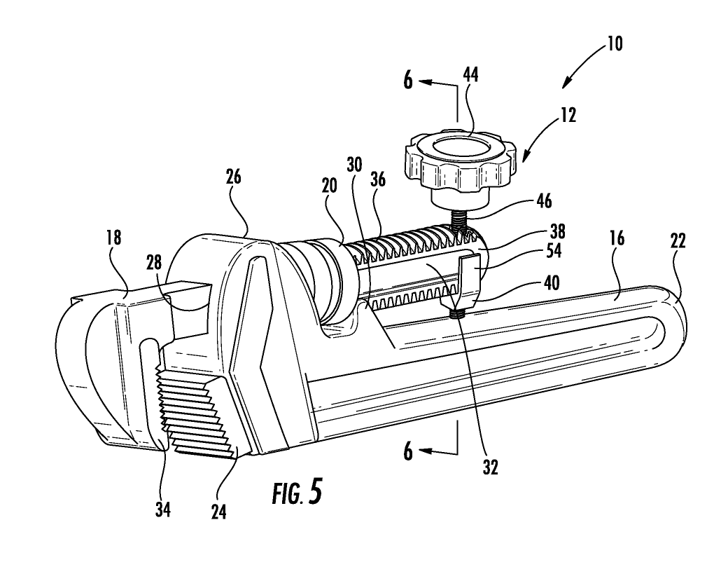

In another embodiment, shown in FIG. 5, the threaded nut element 40 includes at least one wing element 54 attached thereto that extends away from the threaded nut element 40 and adjacent to the terminal end 38 of the lever arm 32 to prevent the threaded nut element 40 from turning as the turn handle 44 turns the threaded shaft 46. In another embodiment, the threaded nut element 40 includes two wing elements 54 extending away from the threaded nut element 40, each wing element 54 disposed adjacent to the terminal end 38 of the lever arm 32 to prevent the threaded nut element 40 from turning as the turn handle 44 turns the threaded shaft 46. In one embodiment, the threaded opening 42 of the threaded nut element 40 is disposed between the terminal end 38 of the lever arm 32 and the handle 16 of the adjustable wrench 10.

In use, the threaded shaft 46 of the grip enhancing apparatus 12 extends through the passageway 48 in the terminal end 38 of the lever arm 32 and engages the threaded opening 42 of the threaded nut element 40. The at least one wing element 54 of the threaded nut element 40 may contact the terminal end 38 of the lever arm 32 and prevent the threaded nut element 40 from turning when the threaded opening 42 of the threaded nut element 40 is being engaged by the threaded shaft 46. As the threaded shaft 46 continues to engage the threaded nut element 40, the threaded shaft 46 ultimately contacts the handle 16 of the adjustable wrench 10. As the turn handle 44 of the grip enhancing apparatus 12 is turned and continues to force the threaded shaft 46 to engage the handle 16, the lever arm 32 of the L-shaped movable jaw 18 is forced away from the handle 16 and the serrated jaw 34 of the L-shaped movable jaw 18 is forced toward the flat serrated jaw surface 24 of the handle 16. At a certain point, the work object 14 is securely engaged by the serrated jaw 34 of the L-shaped movable jaw 18 and the flat serrated jaw surface 24 of the handle 16 and the wrench 10 can remain engaged on the work object 14 without a user having to maintain any pressure on the wrench 10 or hold the wrench 10.

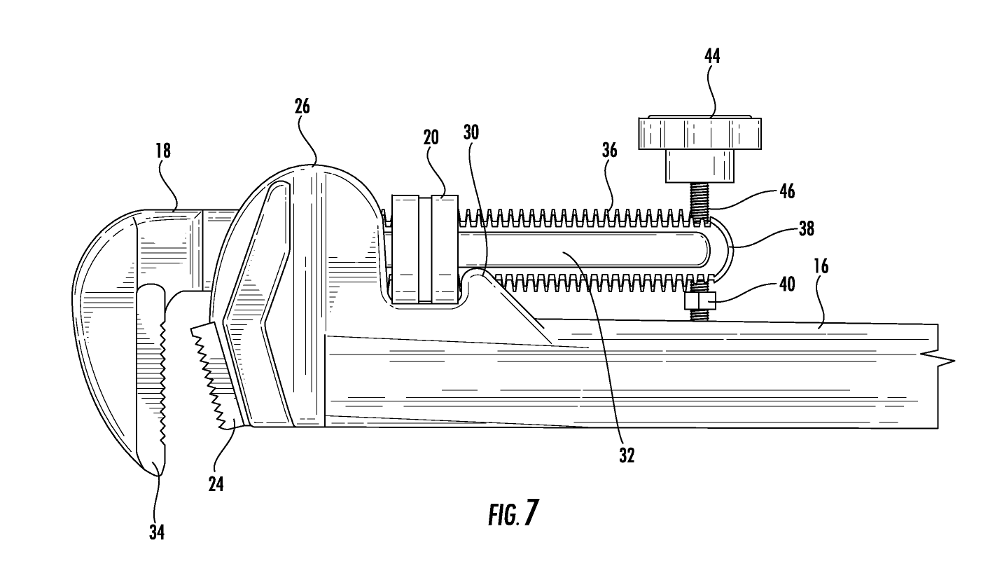

In yet another embodiment, shown in FIG. 7, the threaded nut element 40 is a nut, or a hexagonal nut. The threaded nut element 40 permits the threaded shaft 46 to extend therethrough. The threaded nut element 40 can be disposed between the terminal end 38 of the lever arm 32 and the handle 16 of the adjustable wrench 10. In another embodiment, the turn handle 44 can be attached to the threaded nut 40.

In use, the threaded shaft 46 of the grip enhancing apparatus 12 extends through the passageway 48 in the terminal end 38 of the lever arm 32 and engages the threaded nut element 40. As the threaded shaft 46 continues to engage the threaded nut element 40, the threaded shaft 46 ultimately contacts the handle 16 of the adjustable wrench 10. As the turn handle 44 of the grip enhancing apparatus 12 is turned and continues to force the threaded shaft 46 to engage the handle 16, the lever arm 32 of the L-shaped movable jaw 18 is forced away from the handle 16 and the serrated jaw 34 of the L-shaped movable jaw 18 is forced toward the flat serrated jaw surface 24 of the handle 16. At a certain point, the work object 14 is securely engaged by the serrated jaw 34 of the L-shaped movable jaw 18 and the flat serrated jaw surface 24 of the handle 16 and the wrench 10 can remain engaged on the work object 14 without a user having to maintain any pressure on the wrench 10 or hold the wrench 10.

From the above description, it is clear that the present disclosure is well adapted to carry out the objectives and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. An adjustable wrench for engaging a work object, the wrench comprising:
a handle having a handle end and a flat serrated jaw surface;
an L-shaped movable jaw having a lever arm and a serrated jaw, the lever arm having a terminal end and an opening therein;
a projection extending from the handle having a tunnel therein for accepting the lever arm of the L-shaped movable jaw; and
a grip enhancing apparatus, the grip enhancing apparatus comprising:
a threaded nut element disposed adjacent to the lever arm, the threaded nut element having a threaded opening therein; and
a threaded shaft for extending through the opening of the lever arm and engaging the threaded opening of the threaded nut element, the threaded shaft extendable through the threaded nut element to contact the handle of the adjustable wrench to force the L-shaped movable jaw away from the handle and force the serrated jaw of the L-shaped movable jaw toward the flat serrated jaw surface.

2. The wrench of claim 1 wherein the grip enhancing apparatus further comprises a turn handle attached to the threaded shaft.

3. The wrench of claim 1 wherein the threaded nut element further comprises a ring portion that extends around the lever arm of the L-shaped movable jaw to prevent the threaded nut element from rotating as the threaded nut is engaged by the threaded shaft, the ring portion having an opening therein for receiving the threaded shaft.

4. The wrench of claim 3 wherein the threaded nut element is positioned between the lever arm and the handle.

5. The wrench of claim 3 wherein the threaded nut element is positioned on a side of the lever arm that is opposite of the side nearest the handle.

6. The wrench of claim 1 wherein the threaded nut element further comprises at least one wing element extending away from the threaded nut element and is positioned adjacent to one side of the lever arm to prevent the threaded nut element from rotating as the threaded nut is engaged by the threaded shaft.

7. The wrench of claim 6 wherein the threaded nut element is positioned between the lever arm and the handle.

8. The wrench of claim 6 wherein the threaded nut element is positioned on a side of the lever arm that is opposite of the side nearest the handle.

9. The wrench of claim 1 wherein the threaded nut element further comprises two wing elements extending away from the threaded nut element, each wing element positioned adjacent to each side of the lever arm to prevent the threaded nut element from rotating as the threaded nut is engaged by the threaded shaft.

10. The wrench of claim 9 wherein the threaded nut element is positioned between the lever arm and the handle.

11. The wrench of claim 2 wherein the turn handle is attached to the threaded nut between the lever arm and the handle.

12. The wrench of claim 1 wherein the threaded nut element is a hexagonal nut.

13. The wrench of claim 1 wherein the threaded nut element has a turn handle attached thereto.
